(19) United States
(12) Patent Application Publication
(10) Pub. No.: US 2009/0084039 A1
(43) Pub. Date: Apr. 2, 2009

(54) COMMUNICATION FLAP AND AIRCRAFT PROVIDED WITH ONE SUCH FLAP

(75) Inventors: Bernard Guering, Montrabe (FR); Bernard Groh, Castelginest (FR); Christian Bergeret, Saint Orens de Gameville (FR)

Correspondence Address: PERMAN & GREEN, 425 POST ROAD, FAIRFIELD, CT, 06824, US

(73) Assignee: AIRBUS FRANCE, Toulouse Cedex 9 (FR)

(21) Appl. No.: 11/917,791

(22) PCT Filed: Jun. 6, 2006
(86) PCT No.: PCT/FR2006/001022

§ 371 Date: Aug. 13, 2008

(30) Foreign Application Priority Data
Jun. 16, 2005 (FR) 05 51643
Jun. 6, 2006 (FR) PCT/FR2006/001022

(51) Int. Cl. E06B 3/48

(52) U.S. Cl. 49/109

(57) ABSTRACT

A communication flap including a door for closing or freeing the access to an opening on a wall, the door having at least two leaves. A first leaf is pivotably mounted on the wall in such a way as to open and close the door, and a second leaf is pivotably mounted on the first leaf in such a way as to enable a range of movement around the first leaf. The disclosed embodiments also relate to an aircraft provided with one such flap.

### CROSS REFERENCE TO RELATED APPLICATIONS

This application is the National Stage of International Application No. PCT/FR2006/001022, International Filing Date, 6 Jun. 2006, which designated the United States of America, and which International Application was published under PCT Article 21 (2) as WO publication No. WO2006/134242 and which claims priority from French Application No. 0551643, filed 16 Jun. 2005, the disclosures of which are incorporated herein by reference in their entireties.

### BACKGROUND

1. Field

The disclosed embodiments relate to a communication hatch for closing or freeing access to a doorway formed in a partition such as a floor, a ceiling or a wall. More specifically, the disclosed embodiments relate to a hatch having an opening and closing system such that the hatch can be positioned in a confined or congested area.

2. Brief Description of Related Developments

The hatch according to the disclosed embodiments can be applied, in particular, in the field of aviation, for example in flight decks, to serve as a communication hatch between an upper level, where the pilots' seats are located, and a lower level, where a pilots' rest area is located. Flight decks in aircraft are generally small and congested, and consequently the available floor space for installing a communication hatch is limited.

There is a known hatch for communication between two levels, or more generally between two volumes, in which the door is provided with a single leaf mounted rotatably on the partition separating the two volumes. The leaf has a range of movement about an axis of rotation parallel to the partition. The radius of travel of the door, and consequently the space occupied by the door when it is at least partially open, increases with an increase in the size of the doorway. It is therefore essential to provide sufficient free space around the hatch to allow for the travel of the door. Such a prior art solution is therefore unsuitable for small, confined or congested spaces, in which the available space for the travel of the door is inevitably limited.

Also known in the prior art is a hatch whose door is provided with two independent leaves. Each leaf is mounted rotatably on an opposite edge of the opening. The two leaves can be opened and closed independently of each other. This solution enables the space required for the travel of said door to be distributed on each side of the doorway. The range of movement of each of the two leaves of a given door is smaller than the range of movement of the same door provided with a single leaf. This enables a hatch to be opened and closed in areas having a smaller free area on each side of the doorway.

However, for this solution using a hatch with two leaves, a free space must be created on each side of the hatch, to permit the travel of the two leaves. Thus, if the hatch is provided in the proximity of an obstacle, this solution cannot be used, since the obstacle may impede the travel of one of the two leaves.

### SUMMARY

The disclosed embodiments are intended to resolve these problems by proposing a hatch provided with a door whose travel is such that it can be opened in all cases, and particularly in the presence of an obstacle located in the proximity of said hatch.

For this purpose, the hatch according to the disclosed embodiments are provided with a door having at least two leaves hinged on each other. Only one of the leaves is connected to the partition in which the opening is formed. The second leaf is connected to the first leaf only, and is hinged on the latter. Thus the first leaf is mounted pivotably on the partition, while the second leaf is mounted pivotably on the first leaf.

When the hatch is opened, if the door does not encounter any obstacle, the two leaves extend in the same plane and are opened and closed simultaneously, by rotation of the door about the axis of rotation connecting the first leaf to the partition. On the other hand, if an obstacle is located in the proximity of the hatch, in the radius of travel of the door and more specifically on the path of the second leaf of the door, said second leaf, when coming into contact with the obstacle, is deflected with respect to the first leaf, so as to pass the obstacle. In this case, each of the two leaves has its own travel, relative to the partition and relative to the first leaf respectively. When the second leaf ceases to be in contact with the obstacle, it swings so as to extend once more in the plane of the first leaf.

If the door has more than two leaves, the first leaf is connected to the partition, each subsequent leaf being connected to the preceding leaf. Thus, with the exception of the first and last leaf, each leaf is flanked by two adjacent leaves and is hinged on these two leaves.

The hatch can be formed in such a way that the hatch can be partly opened, using only the second, or last, leaf, while keeping the first leaf, or all the other leaves, closed in order to partially close the doorway. However, the opening of the first leaf necessarily causes all the subsequent leaves to be opened, either simultaneously, if the door does not encounter any obstacle, or in an associated but independent way, if at least one of the subsequent leaves encounters an obstacle.

The second leaf is, for example, mounted pivotably on the first leaf by means of a flexible joint. Preferably, a return force of the flexible joint is sufficient to keep the two leaves of the door in contact at all times.

The disclosed embodiments therefore propose a communication hatch having a door intended to close or free access to an opening in a partition, the door having at least two leaves, characterized in that a first leaf is mounted pivotably on the partition, in such a way that the door can be opened and closed, and a second leaf is mounted pivotably on the first leaf in such a way as to travel around the said first leaf.

The term “pivotably” signifies that the leaf in question can swing to either side of the element on which it is mounted. The “travel” of a leaf signifies the range of movement of said leaf with respect to its resting position, corresponding to the position in which the leaf is contained within the plane of the partition. The partition can be a wall, a floor, a ceiling or any other separating barrier between two volumes.

In examples of embodiment of the hatch according to the disclosed embodiments, it is possible to provide any or all of the following supplementary features:

The two leaves are connected to each other by a hinge device having resilient return means.

The hinge device is provided with two long frames, each long frame conforming in shape at least partially to one edge of a leaf, in such a way that the two long frames face each other at least partially, the resilient return means being fixed to the long frames.

The term “long frame” signifies a frame for containing one edge of a leaf at least partially, in other words by running along some or all of the length of said edge. The edges, or sides, of the leaves in question are the junction edges, in other words the edges by which the two leaves are connected.

The resilient return means include at least one resilient tensioner connected to the two leaves. The tensioner is, for example, a resilient belt or strip for keeping the two leaves in tension.

The resilient return means include a plurality of resilient tensioners, each resilient tensioner being fixed by a first end to a first leaf and by a second end to the second leaf so as to connect the two leaves to each other at separate points.

The term “at separate points” signifies “at different points, spaced apart to a greater or lesser degree, along the junction edges of the leaves”.

The travel of the second leaf is independent of the travel of the first leaf.

The disclosed embodiments also relate to an aircraft provided with at least one such hatch according to the disclosed embodiments. For example, the communication hatch may be located behind a seat adapted to have at least one position in which it forms a stop for the second leaf.

The disclosed embodiments will be clarified by the following description and by the accompanying figures. The figures are provided for information only and do not limit the disclosed embodiments in any way. The content of the figures is as follows:

### BRIEF DESCRIPTION OF THE DRAWINGS

FIGS. 1A to 1D are schematic illustrations of a hatch according to the disclosed embodiments in the closed position (FIG. 1A) and in different open positions (FIGS. 1B, 1C and 1D);

FIGS. 2A and 2B are illustrations of a hatch according to the disclosed embodiments, with the door of the hatch encountering an obstacle during opening;

FIGS. 3A and 3B are schematic illustrations of a hatch according to the disclosed embodiments, with the door of the hatch encountering an obstacle during closing;

FIGS. 4A to 4C show enlarged views of the hatch according to the disclosed embodiments in the area of the joint between the first and second leaves;

FIG. 5 is an illustration of a cockpit of an aircraft provided with a hatch according to the disclosed embodiments;

FIG. 6 is another illustration of a cockpit of an aircraft provided with a hatch according to the disclosed embodiments.

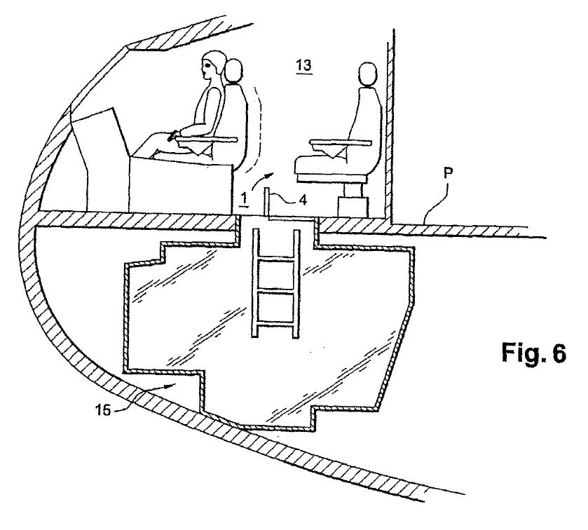

### DETAILED DESCRIPTION OF THE DRAWINGS

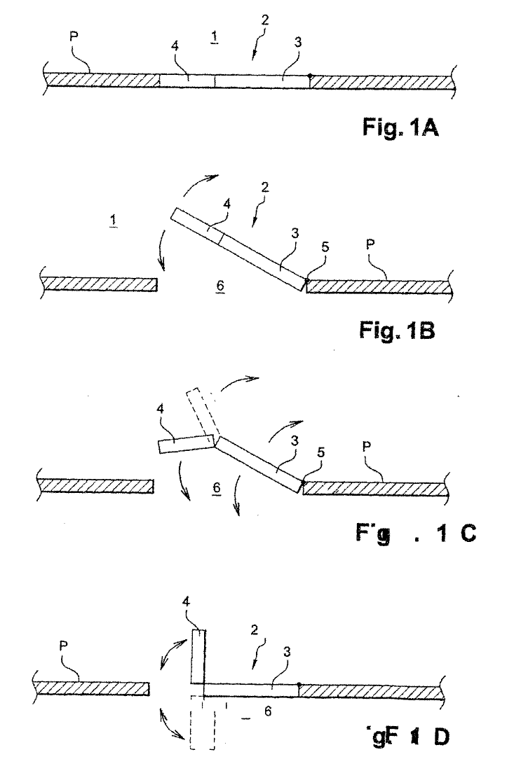

FIG. 1A shows a hatch 1 in a floor P. The hatch 1 is provided with a door 2, formed by two leaves 3 and 4, closing an opening formed in the floor P. The door 2 is closed in such a way that the leaves 3 and 4 extend in the plane of the floor P.

In FIG. 1B, the door 2 is open. The first leaf 3 is fixed to the floor P by a hinge 5 mounted rotatably on the floor P. The second leaf 4 extends in the plane of the first leaf 3 in such a way that the door 2 appears to be a door with only one leaf. The opening of the door 2 allows access to the opening 6 formed in the floor P. The range of travel of the door 2 is, for example, 180° about the axis of rotation, in such a way that the door 2 can have two opposing extreme positions, namely a resting position in which it closes the opening 6 and an active position in which it completely frees access to the opening 6 and is superimposed on the floor P. It is also possible to make a door 2 whose range of travel is less than 180°, for example about 90°.

FIG. 1C shows different possible travels of each of the two leaves 3 and 4 of the door 2. The first leaf 3 can have a swinging movement about the axis of rotation passing through the hinge 5. The second leaf 4, mounted rotatably on the first leaf 3, has a travel which can be independent of the travel of the first leaf 3. Thus the second leaf 4 can pivot about an axis of rotation passing through the joint between the first leaf 3 and the second leaf 4, so as to swing on either side of the first leaf 3.

The position of the second leaf 4 with respect to the first leaf 3 depends on any obstacles which the second leaf 4 encounters during the opening and/or closing of the door 2. In a specific example of embodiment, if there is no obstacle impeding the opening of the door 2 in the path of the second leaf 4, said second leaf 4 extends in the plane of the first leaf 3.

FIG. 1D shows another example of the opening of the door 2 according to the disclosed embodiments. The first leaf 3 is in the resting position; in other words it extends in the plane of the floor P so as to close the opening 6. The second leaf 4 is open, and extends in a plane perpendicular to the plane of the floor P. Thus it is possible to open the door 2 partially. As described more fully in the remainder of the description, such a partial opening of the door 2 may prove to be particularly advantageous in an aircraft, particularly for compensating for pressure differences between two levels or volumes.

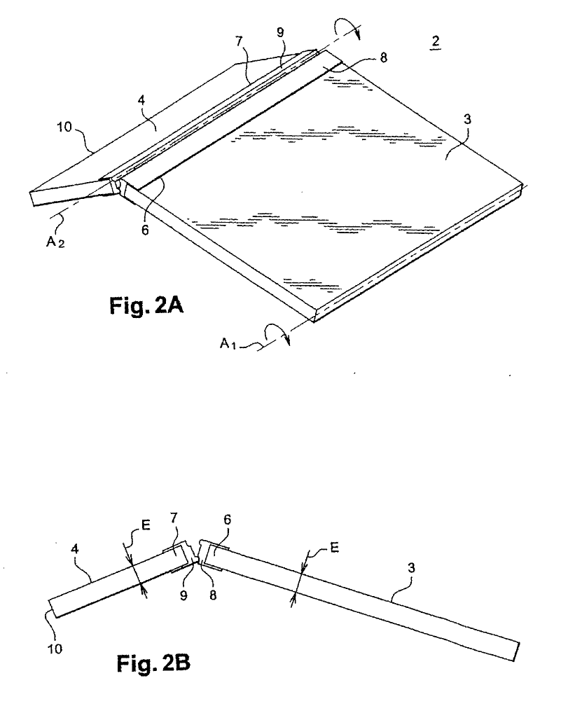

FIGS. 2A and 2B show the door 2 according to the disclosed embodiments during opening, when an obstacle (not shown) obstructs the opening in the path of the second leaf 4 of the door 2.

The first leaf 3 is raised with respect to the floor by rotation about a first axis of rotation A1 passing through the hinge (not shown) connecting the first leaf 3 to the floor.

The second leaf 4 extends in a plane other than the plane containing the first leaf 3. One edge 7 of the second leaf 4, which is in contact with an edge 6 of the first leaf 3, is located above the edge 10 of the second leaf 4 forming the free end of the door 2. The term “free end 10 of the door 2” signifies the end of the door 2 opposite the end mounted rotatably on the floor. The free end 10 of the door 2 is, for example, in contact with an obstacle (not shown) which causes the second leaf 4 to pivot, thus moving said second leaf 4 downward with respect to the floor. The second leaf 4 pivots about an axis of rotation A2 extending along the joint between the two leaves 3 and 4.

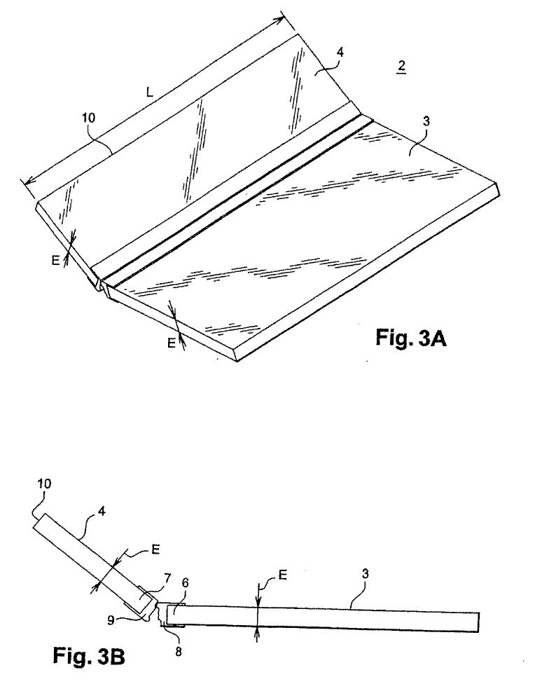

In the example shown in FIGS. 3A and 3B, the door 2 encounters an obstacle while it is being closed. The first leaf 3 is in the resting position, in other words in a position in which it closes the opening 6 formed in the floor P, while the second leaf 4 projects with respect to the first leaf 3.

FIGS. 2A, 2B, 3A and 3B show an example of embodiment of the joint between the first leaf 3 and the second leaf 4 of the door 2.

Each of the leaves 3 and 4 is provided with a long frame 8 and 9 respectively. Each long frame 8, 9 extends along the length of the junction edges 6, 7 of the leaves 3, 4. The junction edges 6, 7 face each other in such a way that the long frames 8, 9 also face each other.

In the example shown in FIGS. 2A, 2B, 3A and 3B, the long frames 8 and 9 extend over the whole length L of the junction edges 6 and 7. The term “length L” signifies the dimension of the junction edges 6 and 7 parallel to the axis of rotation A2. In another example of embodiment, it is possible to make the long frames 8 and 9 only partially contain the junction edges 6 and 7 of the leaves 3 and 4.

The cross section of the long frames 8 and 9 is, for example, generally U-shaped, the cavity 17 formed between the branches of the U being such that it can contain a thickness E of the leaves 3 and 4. The term “thickness E of the leaves 3 and 4” signifies the dimension of said leaves 3 and 4 perpendicular to the axis of rotation A2. The long frames 8 and 9 are, for example, held on the leaves 3 and 4 by tight contact, or by screws, adhesive, or any other fixing means.

The long frames 8 and 9 belong to a hinge device 11 enabling the second leaf 4 to rotate with respect to the first leaf 3.

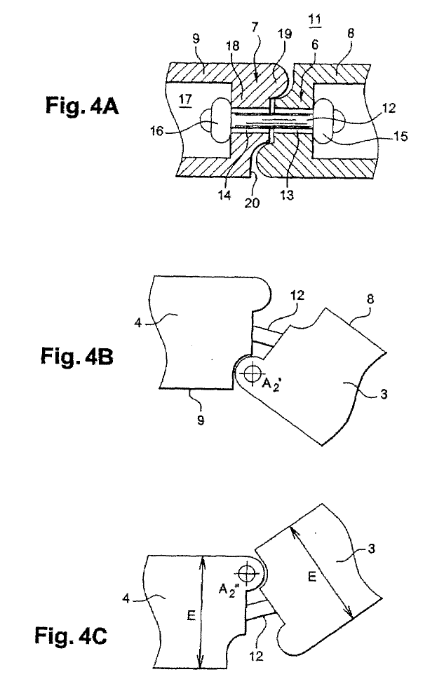

FIGS. 4A, 4B and 4C show in greater detail an example of embodiment of the hinge device 11 for connecting the second leaf 4 to the first leaf 3.

The hinge device 11 includes the two long frames 8 and 9 and at least one resilient tensioner 12. Each long frame 8, 9 is provided with a hole 13, 14 through which the resilient tensioner 12 passes. Each end 15, 16 of the resilient tensioner 12 bears on the wall bordering a hole 13, 14, in such a way that said elastic tensioner 12 is held on the two long frames 8, 9. Thus the resilient tensioner 12 enables the two long frames 8, 9, and consequently the two leaves of the door, to be kept under tension.

In one example of embodiment, the hinge device 11 can be provided with a plurality of resilient tensioners 12 positioned along the length of the leaves 3 and 4, each resilient tensioner 12 passing through the two long frames 8, 9. In this case, the joint between the two leaves 3 and 4 is a joint at separate points, with each resilient tensioner 12 at one point.

In another example of embodiment, a single resilient tensioner 12 can be provided with a sufficient length to pass through each of the two long frames 8, 9 more than once, following a sinuous path between the two long frames 8, 9. The term “length of the resilient tensioner 12” signifies the dimension of said tensioner 12 between its two ends 15, 16. This solution is particularly advantageous in that it allows easy adjustment or readjustment of the tension of the resilient tensioner 12 and therefore of the return force between the two leaves 3, 4. This is because it is simply necessary to detach the resilient tensioner 12 at one of its ends 15, 16 and to pull on said end 15, 16 so as to stretch the resilient tensioner 12 and obtain the desired tension.

It is also possible to have a single resilient tensioner 12 whose width is substantially equal to the length of the long frames 8 and 9. The term “width of the resilient tensioner 12” signifies the dimension of said tensioner 12 perpendicular to the length of the resilient tensioner 12. For example, the resilient tensioner 12 is provided with two sliding pieces, forming the ends 15, 16 of the resilient tensioner 12 and located in each cavity 17 of the long frames 8, 9, and with an intermediate part passing through the holes 13, 14 of the long frames 8, 9.

Each long frame 8, 9 has, on its junction edge 6, 7, a protuberance 19 and an indentation or cut-out 20. The protuberance 19 and the indentation 20 extend along the whole length of the junction edges 6, 7. The long frames 8, 9 are positioned with respect to each other in such a way that the protuberance 19 of the first long frame 8 coincides with the indentation 20 of the second long frame 9. Similarly, the protuberance 19 of the second long frame 9 coincides with the indentation 20 of the first long frame 8. The protuberance 19 of the first long frame 8 is complementary to the indentation 20 of the second long frame 9, and vice versa. The term “complementary” signifies that a profile of an indentation 20 conforms in shape to a profile of the protuberance 19 located opposite it.

The swinging movement of the second long frame 9 with respect to the first long frame 8, corresponding to the swinging movement of the second leaf 4 with respect to the first leaf 3, can take place about two different axes of rotation A2′, A2″, depending on the direction of travel.

In FIG. 4B, the second leaf 4 pivots upward with respect to the first leaf 3 about an axis of rotation A2′ passing through the protuberance 19 formed on the first long frame 8. Conversely, as shown in FIG. 4C, the second leaf 4 pivots downward with respect to the first leaf 3 about an axis of rotation A2″ passing through the protuberance 19 formed on the second long frame 9.

Advantageously, in order to provide the longest possible lever arm, the axes of rotation A2′ and A2″ are located as far as possible away from each other; in other words, each of the axes of rotation A2′ and A2″ is located at an opposite end of the thickness E of the leaf 3, 4 in question.

Advantageously, the return force of the resilient tensioner 12 is such that the leaves 3 and 4 are in permanent contact, either over the whole thickness E of said leaves 3, 4 (FIG. 4A) or only at the location of a protuberance 19 and of an associated indentation 20 (FIGS. 4B and 4C).

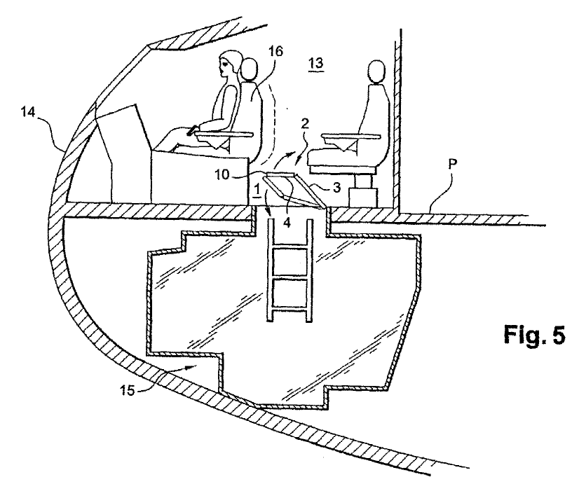

FIG. 5 shows an example of the use of the hatch 1 according to the disclosed embodiments in an aircraft 14.

The hatch 1 is located in a cockpit 13 of the aircraft 14. A cockpit is generally a cramped and congested space, in which it is difficult to provide sufficient free floor space to allow a hatch to be opened. However, in some aircraft, a hatch 1 has to be provided for communication between the flight level and the lower level, located under the floor P of the aircraft 14, to allow access to a lower room 15 used, in particular, as a rest area for the pilots.

The hatch 1 is generally positioned behind the pilot's seat 16. The pilot's seat 16 can have two different extreme positions. In the first extreme position, as shown in FIG. 5, the seat 16 is advanced in such a way that the pilot can access the controls located in front of him. In a second extreme position, shown in broken lines in FIG. 5, the seat 16 is slightly retracted from its flying position. In this second extreme position, the seat 16 can impede the opening or closing of the door 2 of the hatch 1.

If the hatch 1 according to the disclosed embodiments are used, the door 2 can be opened and closed regardless of the position of the pilot's seat 16. For this purpose, the free end 10 of the door 2 is placed nearer to the seat 16, the door 2 traveling toward the rear of the seat 16.

When the seat 16 is in the flying position, in other words in the first extreme position, it does not form an obstacle to the opening and/or closing of the door 2. In this case, the two leaves 3, 4 extend in the same plane at all stages of the opening and closing of the door 2.

1. A communication hatch having a door close or free access to an opening in a partition, the door having at least two leaves, a first leaf being mounted pivotably on the partition, configured so that the door can be opened and closed, a second leaf being mounted pivotably on the first leaf to provide travel around the first leaf, wherein the two leaves are connected to each other by a hinge device having resilient return means for bringing the second leaf back into the extension of the first leaf.

2. The hatch as claimed in claim 1, wherein the hinge device is provided with two long frames each long frame conforming in shape at least partially to one edge of a leaf, the two long frames facing each other at least partially, the resilient return means being fixed to the long frames.

3. The hatch as claimed in claim 1, wherein the resilient return means include at least one resilient tensioner connected to the two leaves.

4. The hatch as claimed in claim 1, wherein the resilient return means includes a plurality of resilient tensioners, each resilient tensioner being fixed by a first end to the first leaf and by a second end to the second leaf to connect the two leaves to each other at separate points.

5. The hatch as claimed in claim 1, wherein the travel of the second leaf is independent of the travel of the first leaf.

6. An aircraft having at least two levels, comprising at least one communication hatch as claimed in claim 1 between the two levels.

7. The aircraft as claimed in claim 6, wherein the communication hatch is located behind a seat adapted to have at least one position in which the seat forms a stop for the second leaf of the hatch.
